(19) United States
(12) Patent Application Publication
(10) Pub. No.: US 2012/0246678 A1
(43) Pub. Date: Sep. 27, 2012

(54) Distance Dependent Scalable User Interface

(76) Inventor: Tobe Barksdale, Bolton, MA (US)

(21) Appl. No.: 13/070,596

(22) Filed: Mar. 24, 2011

(51) Int. Cl. H04N 5/445

(52) U.S. Cl. 725/37

(57) ABSTRACT

A graphical user interface control for a home entertainment system. The distance between a user and a display is determined. The informational content of the graphical user interface and the size of the text and graphic images shown on the display are scaled based on the distance of the user from the display.

### BACKGROUND

This specification describes a scalable graphical user interface for a home entertainment system.

### SUMMARY

In one aspect of the specification, a home entertainment system includes a display for displaying information to a user. The information includes a plurality of fields. The home entertainment system also includes a distance detector for determining a quantity representative of the distance of a user from the display; a user interface (UI) controller for controlling, responsive to the distance detector, at least one of the number of data fields to be displayed on the television screen; and the number of user choices to be displayed. The display may be a television. The display may be an element of a non-television electronic device. The non-television electronic device may be a music reproduction device. One of the plurality of fields may be graphic images. The UI controller further be for sizing the graphic image. The UI controller may be further for determining the text size. The UI controller may determine a graphics scaling factor and a text scaling factor independently. The distance detector may be integrated into a game controller. The UI controller may be configured to fit the UI into a predetermined available space. The predetermined available space may be substantially the entire display. The predetermined available space may be a window of the display. The UI controller may be configured to prevent abrupt changes in the sizing of the text and the number of fields displayed. The distance detector may be a motion detector. The distance detector may include three dimensional sensing technology. At least a portion of the distance detector may be in the display, the remote control or gaming controller may be free of the distance detector. The distance detector may be configured to provide the distance of a user from the display to components of the home entertainment system. At least a portion of the UI controller may be in a non-display component of the home entertainment system. The distance detector may be active when the remote control is inactive.

In another aspect of the specification, a method for controlling a user interface displayed on a display, includes a determining of a quantity representative of distance of a user from the display; and based on the determining of the distance, determining a number of entries and a number of fields of each entry to be displayed on the screen and determining sizing the text so that the entire element of information fits in a predetermined available space. The method may further include sizing graphic images corresponding with the entries so that the combined text and graphics fits in the predetermined available space. The sizing of the text and the sizing of the graphic images may be independent. The display may be associated with a non-television electronic device.

In another aspect of the specification, a user interface controller for a television, includes circuitry for determining, based on the distance of a user remote control from a display the number of entries to be shown on the display and the number of text fields of each entry to be shown on the display, and circuitry for sizing the text so that the entire entry fits into the available space.

Other features, objects, and advantages will become apparent from the following detailed description, when read in connection with the following drawing, in which:

### BRIEF DESCRIPTION OF THE SEVERAL VIEWS OF THE DRAWING

FIGS. 1 and 2 are block diagrams of home entertainment systems;

FIGS. 3A-3C are exemplary representations of television screens;

FIGS. 4A-4E are exemplary representations of television screens; and

FIGS. 5A-5B are diagrammatic views of a user, a remote control, and an electronic device.

### DETAILED DESCRIPTION

Though the elements of several views of the drawing may be shown and described as discrete elements in a block diagram and may be referred to as “circuitry”, unless otherwise indicated, the elements may be implemented as one of, or a combination of, analog circuitry, digital circuitry, or one or more microprocessors executing software instructions. The software instructions may include digital signal processing (DSP) instructions. Unless otherwise indicated, signal lines may be implemented as discrete analog or digital signal lines, as a single discrete digital signal line with appropriate signal processing to process separate streams of audio signals, or as elements of a wireless communication system. Unless otherwise indicated, audio signals may be encoded in either digital or analog form. Some of the processes may be described in block diagrams. The activities that are performed in each block may be performed by one element or by a plurality of elements, and may be separated in time. The elements that perform the activities of a block may be physically separated. Unless otherwise indicated, audio signals or video signals or both may be encoded and transmitted in either digital or analog form; conventional digital-to-analog or analog-to-digital converters may not be shown in the figures.

Modern televisions have large screens, often with a nominal diagonal screen size of 127 cm. (50 inches) or larger, that are viewable from far away, but are often watched from nearby for an immersive experience. Many modern homes have an “open plan”, where a large common living area, often including a kitchen, a dining area, and a “family room” or other living area, are not separated by walls. The evolution of large television screens and large living areas has led to situations where, in a single installation, people might view from far away (six to nine meters or more) or nearby (2 to 4 meters), depending on what the activity is. Furthermore, because a high resolution screen might be used for browsing deep selection lists (that is a selection list that has many entries and many fields), the user might want to get close (0.6 to 1.2 meters) to a rich, detailed display of information.

The farther the user is from the screen, the larger the text and graphics of the user interface (UI) should be for readability. However, merely scaling the UI so that the text is larger can have undesirable effects. For example, if the user is using the UI to select an item from a long list, scaling up the UI can limit the number of selections that can be shown on the screen at one time. If the UI is a window, scaling up the UI can cause the window to be larger than desired or necessary. It may be desirable to modify the amount of information displayed relative to the distance of the viewer from the screen and relative to other factors.

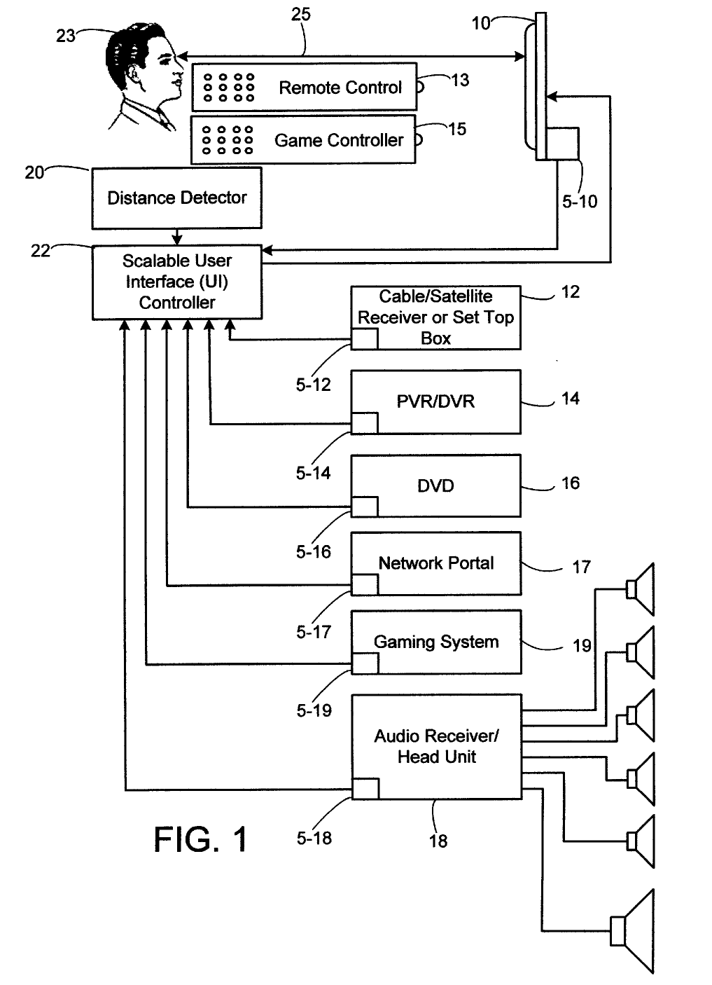

Referring to FIG. 1, there is shown one embodiment of a home entertainment system. The home entertainment system includes devices such as a television 10, cable television or satellite television receiver or set top box 12, a personal video recorder (PVR) or digital video recorder (DVR) 14, a DVD player 16, a network portal 17, a gaming system 19, and an audio receiver or audio head unit 18. Each of the devices has associated with it a user interface generator 5-10, 5-12, 5-14, 5-16, 5-17, 5-19, and 5-18, respectively, coupled to a scalable user interface controller 22. The scalable user interface controller is operationally coupled to a distance detector 20 and the television 10. The home entertainment system may lack one or more of the components shown in this view, there may have additional components and/or the components may be interconnected in different or additional ways, and devices of the home entertainment system may be incorporated in different ways; for example, the television 10 and the audio receiver or head unit may be incorporated.

In operation, each of the user interface generators 5-10, 5-12, 5-14, 5-16, 5-17, 5-18, and 5-19 generates a user interface so that the components can use the television to communicate with the user 23, or in other words to use the television for an on-screen display (OSD). For example, the cable/satellite receiver 12 may use the television 10 to display a UI that may include a list of channels available to the user 23. The PVR/DVR 14 may use the television 10 to display a UI to permit the user to select recorded programs for viewing. The DVD player may use the television to display a UI to permit the user to select a scene or chapter for viewing. The internet portal can use the television in the same manner as a computer display. The audio head unit may use the television to display a UI showing the current volume setting.

The distance detector 20 detects the distance 25 between the user 23 and the television. Based on the distance between the user and the television, the interface controller 22 scales and modifies the user interface information received from the components displayed on the screen, as will be described in more detail below.

Each element of information may include a plurality of fields. For example, an element of information in the UI of a cable/satellite receiver may include a channel number field, a channel title field, a program title field for the program currently being broadcast on that channel, and a brief description field of the program currently being broadcast on that channel. Sometimes only a single element of information is displayed; for example, if the display is being used for a UI from the audio receiver/head unit, the single element of information might be the selection currently being played. Sometimes several elements of information might be displayed; for example if the display is being used for a UI from the audio receiver/head unit, the several elements may include the tracks available for playing, and each element may include a track name field, an artist field, and an album field.

The cable/satellite receiver or set top box 12, the personal video recorder (PVR) or digital video recorder (DVR) 14, the DVD player 16, and the audio receiver or audio head unit 18 may be conventional components equipped to generate an OSD.

The network portal 17 may take a number of forms. For example, the network portal may be an element of a home entertainment system which may receive or transmit video or audio signals from one portion of a home to another. In another example, the network portal may be a computer that has audio or video signals stored in its memory or which receives audio or video signals from a local or wide area network or from the internet. In another example, the network portal may be a telecommunications device such as a radio telephone, which transmits audio or video signals stored in its memory or transmitted to it wirelessly. The network portal may facilitate connection, through its network connection, to other remotely located devices.

The gaming system 19 may be any one of a number of systems that permit the user to interactively control the display on the television, typically by a controller or a motion detection system.

In addition, the home entertainment system may have other elements, such as a interconnection for a multimedia storage device such a an iPod® mobile digital device available from Apple Inc. of Cupertino, Calif., USA.

The distance detector 20 may also take a number of forms. For example, the distance detector may be built into a remote control 13 or gaming system controller 15 so that the distance of the television to the remote control 13 or gaming system controller 15 is used as a proxy for the distance between the television and the user. There are many methods and devices for measuring the distance between a remote control 13 or gaming system controller 15 and a television 10. For example, the remote control may emit an ultrasonic transmission and a infrared transmission simultaneously. The distance can be calculated by the difference in arrival of the infrared transmission and the ultrasonic transmission.

In many circumstances, the distance between the remote control unit 13 or gaming system controller 15 and the television 10 is an accurate proxy for the distance between the user and the television. One of the most common uses for OSDs is to use the television screen to assist the user in entering information from a remote control or to use the gaming system controller 15 to control the video image that is displayed on the screen. In this instance, the user and the remote control 13 and/or game controller 15 are typically co-located.

However, there may be some situations in which a remote control and a user are not co-located. For example, if the television is being used as an OSD for the audio head unit, the information on the screen may be static, for example the name of the audio track currently being played. In this instance, not only are the remote control and the user not likely to be co-located, but the remote control is not likely to be transmitting information, so transmissions of the remote control are not available for use by the distance detector.

In another example, a gaming system may use some method or device other than a gaming system controller to control the video image that is displayed on the television, or an entertainment system may use some method or device other than a remote controller to navigate a UI. Instead, the gaming system or entertainment system may react to physical gestures of the user or audible commands from the user.

In these instances, a motion detector or some other form of distance detector may be more effective. The motion detector may be a simple motion detector or a more complex motion detection system, for example, the KINECT™ controller-free gaming system of Microsoft Corporation of Bellevue Wash. and/or the three dimensional sensing technology developed by PrimeSense Ltd. of Tel Aviv, Israel, that use video cameras, structured light, stereoscopy, triangulation, directional microphones, voice recognition, and other techniques that can track user distance, switch between users, interpret user gestures and utterances, and the like.

In a system using a controller such as the controller in the KINECT™ controller-free gaming system, the sensors that detect object location relative to the display location is preferably sufficiently close such that a determination of a user's location relative to the detector is substantially similar to the distance of the user from the display. A determination that is within approximately 15% or less of the actual distance is sufficiently accurate for proper scaling.

In such a system, the controller can determine which individual in the room is attempting to interact with the system, alter the UI according to the distance that user is from the display, and then change if another user in a different location begins to interact with the display. The device can arbitrate between multiple users by determining which user is farthest from the display, and rendering the UI so it is scaled for the farthest user. Other priority schemes could also be employed.

The device could also scale UI elements, or send information to connected devices such as a audio system with a static display of information, to alter scale as it detects changes in user location, even if the user is not attempting to interact with the system.

Depending on the type of distance detector used, the distance detector 20 may be a standalone device, may be incorporated entirely in the television 10, or some elements of the distance detector may be in the television 10 and some elements in the remote control 13 or game controller 15. Preferably at least a portion of the distance detection system is in the television because the distance between the viewer and the television is a more important parameter than the distance between the viewer and the device generating the OSD. If the distance detector is not a part of the television, it may be co-located with the television.

The scalable UI controller may be a programmable microprocessor which is a part of the control circuitry of the television or one of the components of the home entertainment system, for example the cable/satellite receiver or set top box.

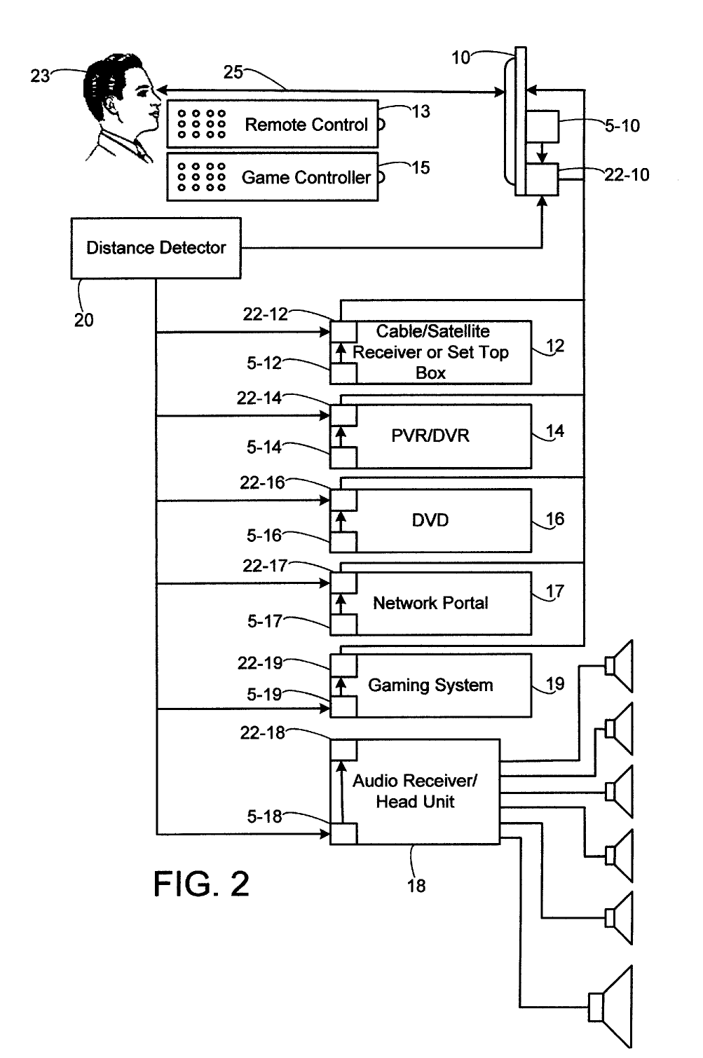

FIG. 2 shows another home entertainment system. The entertainment system of FIG. 2 includes the elements of FIG. 1, except the scalable user interface controller 22. Instead, each of the components 10, 12, 14, 16, 17, and 18 may have a local scalable user interface controller 22-10, 22-12, 22-14, 22-16, 22-17, 22-18, and 22-19, operationally coupled to the distance detector 20. The entertainment system of FIG. 2 operates in a manner similar to the entertainment system of FIG. 1. except the user interface information is scaled or modified by each system component prior to being transmitted to the television. If the scalable UI controller is incorporated in each in each component, the manufacturer of each component can control how its particular UI is altered as a function of distance between the user and the OSD.

The entertainment system of FIG. 2 operates in a manner similar to the system of FIG. 1, except information representative of the distance between the user 23 and the television 10 (for example, the actual distance, a categorization of the distance e.g. “near”, “medium”, “far”, or a calculated scaling factor) is transmitted to each of the components 12, 14, 16, 17, 18, and 19. Distance information can be communicated over a back control channel enabled as part of an HDMI communication link between AV devices, or through some other type of wired or wireless communication interface. Additional information useful for UI scaling may also be communicated. For example, the display device may communicate to all connected devices with scalable UI controllers the size of the display. The scalable UI may then scale its overlay onto the video stream based on both the sensed distance and the display size, so that information and UI elements are rendered at the appropriate size for viewing form the sensed distance.

Each of the user interface generators 5-10, 5-12, 5-14, 5-16, 5-17, 5-18, and 5-19 generates a user interface to overlay onto the video stream so that the components can use the television to communicate information to the user 23, or in other words to use the television for an on-screen display (OSD). Based on the distance between the user 23 and the television 10, each of the local scalable user interface controllers 22-10, 22-12, 22-14, 22-16, 22-17, 22-18, and 22-19 scales and modifies the user interface information that is transmitted to the television.

A system may have some elements of FIGS. 1 and 2. For example, a television and an audio system may share a common UI controller.

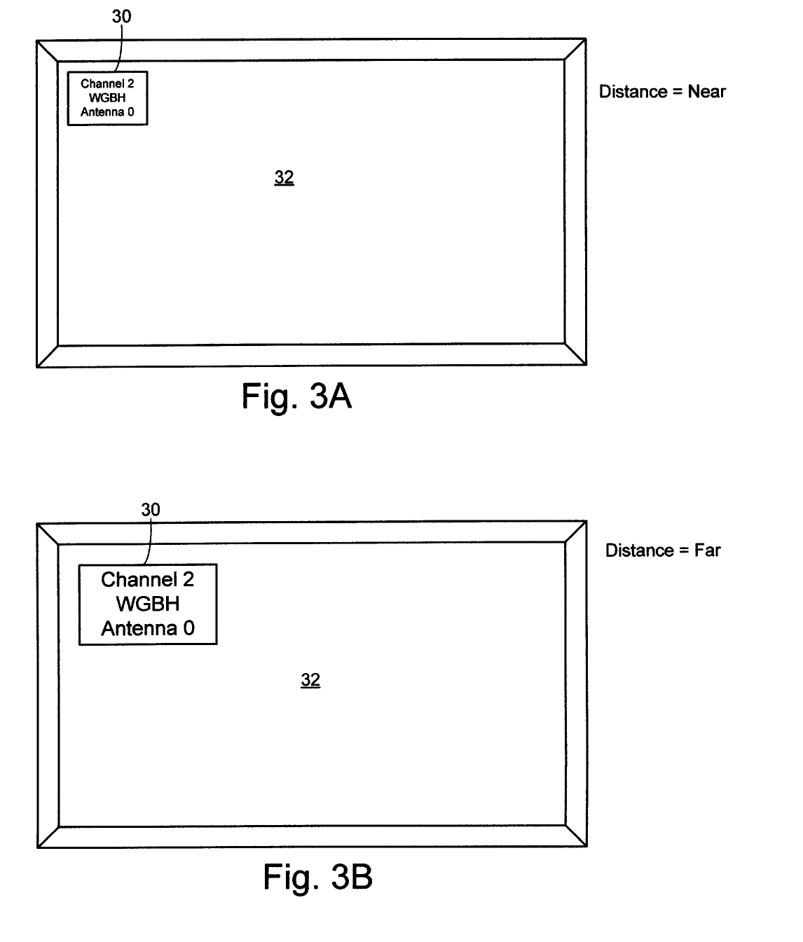

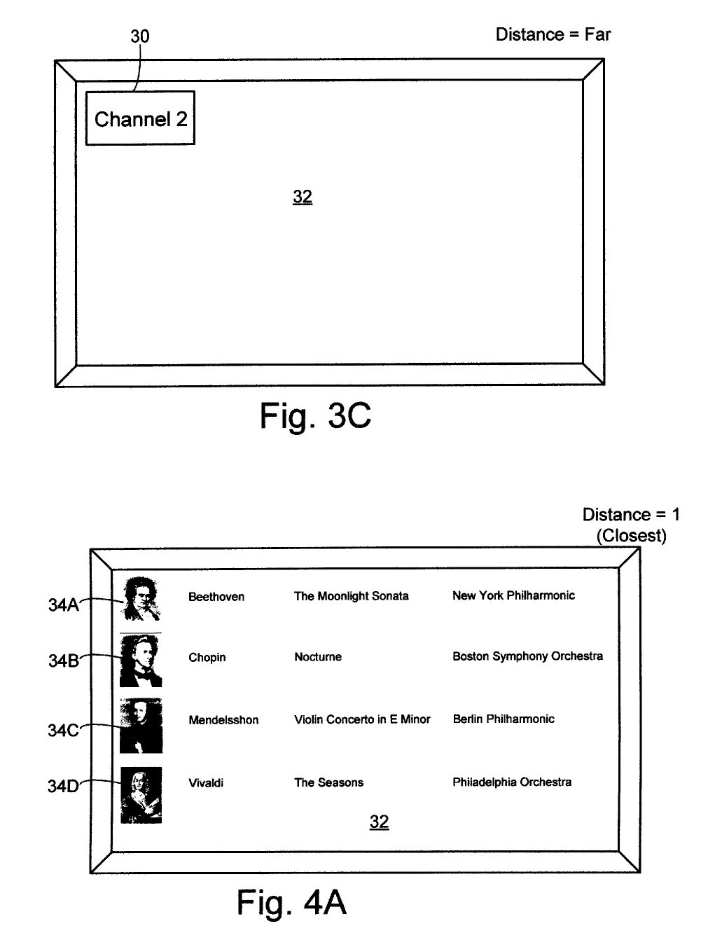

FIGS. 3A-3C show hypothetical screens illustrating one example of the operation of the entertainment system of FIGS. 1 and 2. In FIG. 3A, there appears on the screen 32 an information box 30 showing information including a plurality of fields; for example, fields may be the television channel, an identifier (for example call letters), and the current video source. When the user is near, as in FIG. 3A, the font in which the information is displayed is large enough that the information is legible, but small enough that the box does not take up more screen area than is desirable. In FIG. 3B, in which the user is farther away from the television screen than in the example of FIG. 3A, the information box 30 occupies more area on the screen, but the font is larger so that the information is still legible at the greater distance. Alternatively, in FIG. 3C, in which the user is farther away from the television screen than in FIG. 3A, the information box is kept the same size as in FIG. 3A. In this example, fewer fields are displayed, and the information that is displayed may be sized so that it uses substantially the entire information box without requiring any horizontal scrolling.

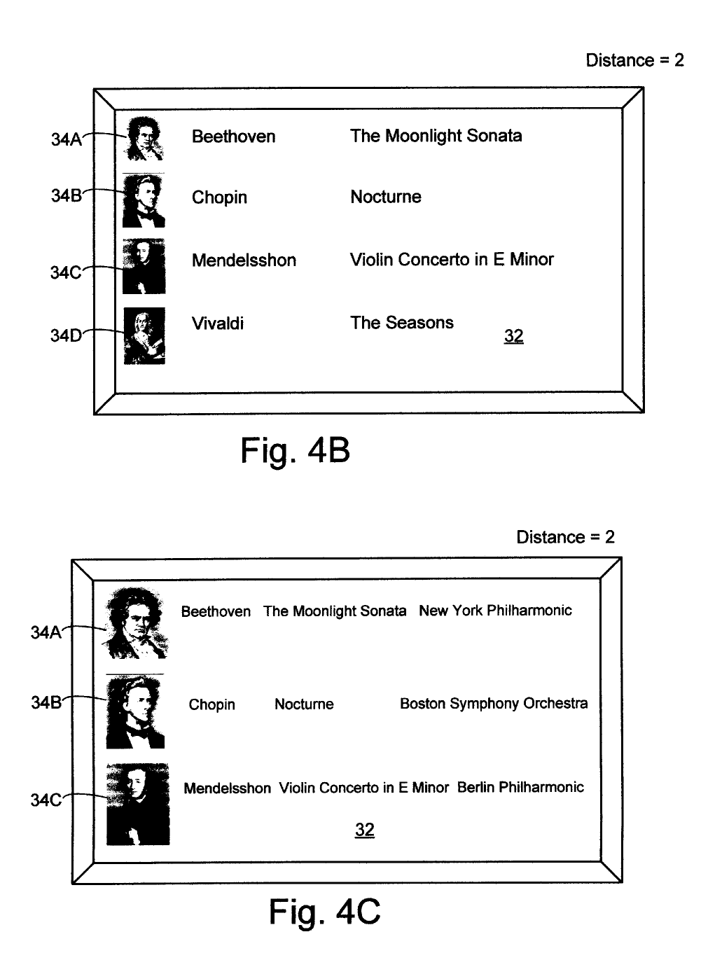

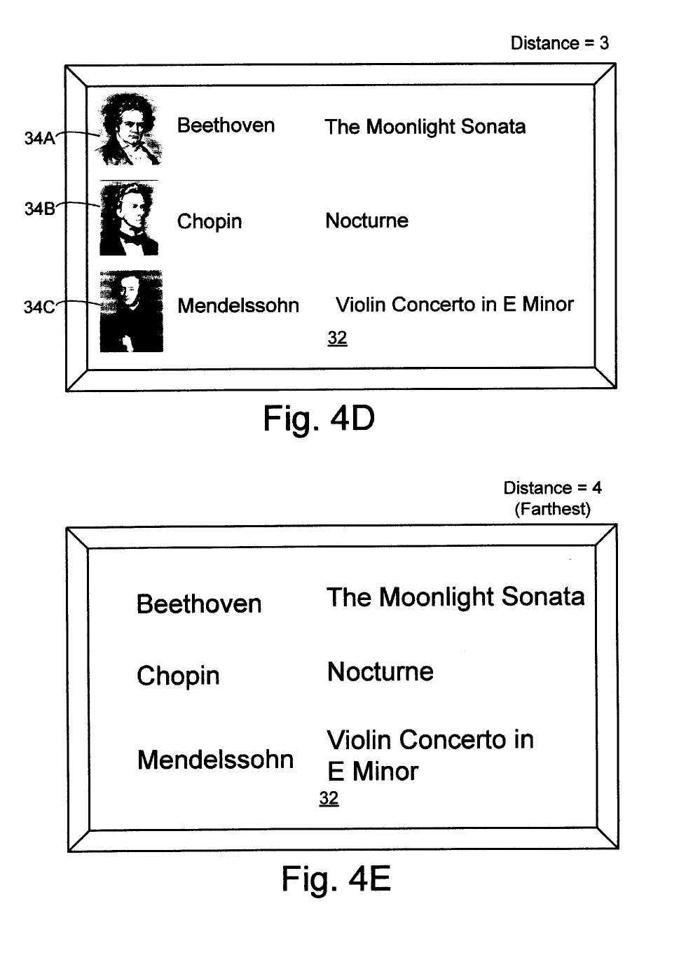

FIGS. 4A-4E illustrate a second example. In the example of FIGS. 4A-4E, the television screen 32 is used for an OSD by the audio head unit to indicate possible selections for the user to choose. In FIG. 4A, the distance detector 20 of previous figures indicates that the user is relatively close to the television screen Since the user is relatively close, the font is relatively small, three fields for each entry are displayed, and each selection includes a graphic image 34A-34D.

In the example of FIGS. 4B and 4C, the distance detector 20 of previous figures indicates that the user is farther from the television screen than in the example of FIG. 4A. In FIG. 4B, two of the three text fields and the graphic images 34A-34D of four entries are displayed.

Alternatively, in the example of FIG. 4C, all three fields and the graphic images of fewer, in this example three, entries are displayed and the font size has been scaled.

The decision whether to show fewer entries as in FIG. 4B or fewer fields as in FIG. 4C can be determined by the UI designer or the system may be designed to accommodate user choice. User choice can also be provided for display characteristics in addition to the number of fields. For example, a sight impaired user may be permitted to choose a font size to correspond with distances from the television.

In the example of FIG. 4D, the distance detector 20 of previous figures indicates that the user is farther from the television screen than in the examples of FIGS. 4A-4C. In the example of FIG. 4D, two fields for each entry are displayed in larger font than in FIGS. 4A-4C, and the graphic images are larger than in FIGS. 4A and 4B. Since the fonts and graphic images are larger only three entries can be displayed at one time, so only the graphic image and two text fields for each are displayed for each entry.

In the example of FIG. 4E, the distance detector of previous figures indicates that the user is farther from the television screen than in the examples of FIGS. 4A-4D. Two fields for the entry are displayed in larger font than in FIGS. 4A-4D, and the graphic images have been omitted.

FIGS. 4A and 4B illustrate another feature of the entertainment system of FIGS. 1 and 2. The font size and the size of the graphics may be processed independently. The words on the screen of FIG. 4A are in smaller font than in FIG. 4A, but the sizes of the graphics images are the same size as in FIG. 4B. Such a situation might be appropriate, for example, if making the graphic images smaller would cause them to be so small that the features of the graphic images are indistinguishable, but the font size can be reduced further (permitting more fields to be displayed on the screen) without making the words illegible at the distance the user is removed from the screen.

Modifying the font size and sizes of the graphic images may be done by at least two methods. In a first method, the size of the letters and numbers and of the graphic images may simply be multiplied based on some relationship to the distance between the user and the television. For example, if the user at position A is 1.5× the distance of the user at position B, the size of the letters, numbers, and graphic images could be scaled up by a factor of 1.5× for position A. In other examples, the scaling factor for position A may be some other factor, for example 1.3× or 1.7×. In other examples, the relationship between the scaling factor and the distance from the screen may be non-linear. The scaling factors for fonts and graphic images could be different, and the scaling factors for fonts and for graphic images could have different maximum and minimum values. To prevent annoyingly continuous change of the font sizes and graphics sizes, the application of the scaling factor or factors could be filtered in some manner.

In a second method, a plurality of ranges can be defined and scaling factors or discrete font size and graphics sizes may be assigned to each range. For example, a distance of greater than 6 meters may be defined as “far”, a distance of 4-6 meters may be defined as “medium distance”, and a distance of less than 4 meters may be defined as “close”. A scaling factor could be defined for the “close” range, the “medium distance” range and for the “far” range. The scaling factor could be different for graphic images and for fonts. The maximum and minimum values for the scaling factor for graphic images could be different than the maximum and minimum values for fonts. To prevent annoyingly continuous change of the font sizes and graphics, some form of hysteresis may be applied. For example, if the “medium distance” scaling factor is currently being applied and the user moves closer to the screen, the scaling factor for “close” range may be applied when the user position becomes 4 meters or less. However, if the user then moves farther from the screen, the scaling factor for “medium distance” may not be applied until the user position becomes 5 meters or more.

The correspondence between user distance from the television screen and font sizes and graphics image scaling factors could be implemented as a look-up table (LUT). To prevent annoyingly abrupt changes in font and graphics image sizes, the changes may be smoothed in some manner or implemented with hysteresis, as described above. If the second method is implemented with a large number of small ranges, the result may begin to appear the same as the first method; if the first method is applied with coarse granularity (for example, distance is measured in meters rather than centimeters or millimeters and scaling factors expressed as integers), the result may begin to appear the same as the first method.

In addition to distance between the viewer and the screen, other factors may be taken into account in determining what information is to be displayed on the screen, how large the text and graphics should be, and how the information on the screen should be modified. For example, display resolution may be communicated to UI scalable controllers and the UI scalable controllers may use the display resolution information to render the UI so it is readable at the sensed distance taking into account the capabilities of the display (for example, font sizes would be chosen to be larger, and information may be reduced on a standard definition display compared to a high resolution display of the same size).

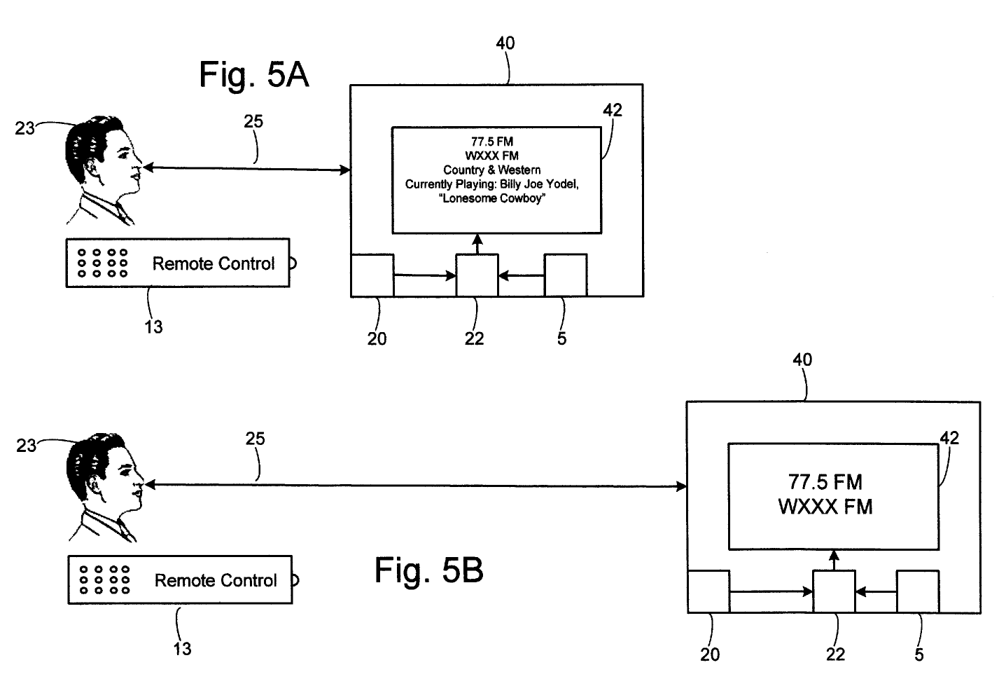

FIGS. 5A and 5B show a device 40, such as a radio, that has a display 42 and is controllable by a remote control 13. A distance detector (in this example, built into the device 40) is operationally coupled to a scalable user interface controller 22. Also operationally coupled to the scalable user interface controller 22 is a UI generator 5.

In operation, the distance detector 20 determines the distance of the user from the device 40. The UI generates a user interface, and the scalable user interface controller selects what information is to be shown on the display and scales the text and graphics to fit the display. For example, in FIG. 5A, the distance detector senses that the user 23 is relatively close. The scalable user interface controller displays all the information fields of available to it. In this example, the radio station carrier frequency, call letters, genre, and the selection currently being broadcast, and other data that may be available in the metadata that is broadcast is displayed. In FIG. 5B, the distance detector 20 determines that the user is relatively far away. The scalable user interface controller displays only one field in a font size that is readable and that fills the display area.

In the example of FIGS. 5A and 5B, the device 40 may be a standalone device, or the device may be one of the components of the entertainment system of FIG. 1 or 2. For example, one of the components 12, 14, 16, 17, 18, or 19 may use the television 10 for OSD and in addition have a digital clock on the chassis of the component.

Numerous uses of and departures from the specific apparatus and techniques disclosed herein may be made without departing from the inventive concepts. Consequently, the invention is to be construed as embracing each and every novel feature and novel combination of features disclosed herein and limited only by the spirit and scope of the appended claims.

What is claimed is:

1. A home entertainment system comprising:
a display for displaying information to a user, the information including a plurality of fields;
a distance detector for determining a quantity representative of the distance of a user from the display;
a user interface (UI) controller for controlling, responsive to the distance detector, at least one of
the number of data fields to be displayed on the television screen; and
the number of user choices to be displayed.

2. The home entertainment system of claim 1, wherein the display is a television.

3. The home entertainment system of claim 1, wherein the display is an element of a non-television electronic device.

4. The home entertainment system of claim 3, wherein the non-television electronic device is a music reproduction device.

5. The home entertainment system of claim 1, wherein one of the plurality of fields comprises graphic images.

6. The home entertainment system of claim 5, wherein the UI controller is further for sizing the graphic image.

7. The home entertainment system of claim 6, wherein the UI controller is further for determining the text size and wherein the UI controller determines a graphics scaling factor and the text scaling factor independently.

8. The home entertainment system of claim 1, wherein the distance detector integrated into a game controller.

9. The home entertainment system of claim 1, wherein the UI controller is configured to fit the UI into a predetermined available space.

10. The home entertainment system of claim 9, wherein the predetermined available space comprises substantially the entire display.

11. The home entertainment system of claim 9, wherein the predetermined available space comprises a window of the display.

12. The home entertainment system of claim 1, wherein the UI controller is configured to prevent abrupt changes in the sizing of the text and the number of fields displayed.

13. The home entertainment system of claim 1, wherein the distance detector comprises a motion detector.

14. The home entertainment system of claim 13, wherein the distance detector comprises three dimensional sensing technology.

15. The home entertainment system of claim 1, wherein at least a portion of the distance detector is in the display, and no portion of the distance detector is in a remote control or gaming controller.

16. The home entertainment system of claim 1, wherein the distance detector is configured to provide the distance of a user from the display to components of the home entertainment system.

17. The home entertainment system of claim 16, wherein at least a portion of the UI controller is in a non-display component of the home entertainment system.

18. The home entertainment system of claim 1, wherein the distance detector is active when the remote control is inactive.

19. A method for controlling a user interface displayed on a display, comprising:
a determining of a quantity representative of distance of a user from the display; and
based on the determining of the distance, determining a number of entries and a number of fields of each entry to be displayed on the screen; and
sizing the text so that the entire element of information fits in a predetermined available space.

20. The method of claim 19 further comprising sizing graphic images corresponding with the entries so that the combined text and graphics fits in the predetermined available space.

21. The method of claim 20, wherein the sizing of the text and the sizing of the graphic images is independent.

22. The method of claim 19, wherein the display is associated with a non-television electronic device.

23. A user interface controller for a television, comprising:
circuitry for determining, based on the distance of a user remote control from a display the number of entries to be shown on the display and the number of text fields of each entry to be shown on the display, and
circuitry for sizing the text so that the entire entry fits into the available space.
